(19) United States
(12) Patent Application Publication
(10) Pub. No.: US 2025/0273068 A1
(43) Pub. Date: Aug. 28, 2025

(54) INFORMATION PROCESSING DEVICE, INFORMATION PROCESSING METHOD, AND COMPUTER PROGRAM

(71) Applicant: SUMITOMO ELECTRIC INDUSTRIES, LTD., Osaka-shi, Osaka (JP)

(72) Inventor: Toshiya YOSHIOKA, Osaka-shi (JP)

(73) Assignee: SUMITOMO ELECTRIC INDUSTRIES, LTD., Osaka-shi, Osaka (JP)

(21) Appl. No.: 18/704,986

(22) PCT Filed: Aug. 10, 2022
(86) PCT No.: PCT/JP2022/030552

§ 371 Date: Apr. 26, 2024

(30) Foreign Application Priority Data
Nov. 12, 2021 (JP) 2021-185181

(51) Int. Cl. G08G 1/081; G08G 1/01

(52) U.S. Cl. CPC G08G 1/081; G08G 1/0112

(57) ABSTRACT

An information processing device, including: a storage unit configured to store therein probe information of a probe vehicle traveling on an inflow road to an intersection; and an information processing unit configured to execute a determination process of determining presence or absence of pulsation on the inflow road. The determination process includes a process of generating time series data of a delay index that is a traffic index indicating a degree of delay in vehicle traffic due to waiting at a traffic signal, the delay index being calculated from the probe information, and a process of determining presence or absence of pulsation, based on the time series data of the delay index.

### TECHNICAL FIELD

The present disclosure relates to an information processing device, an information processing method, and a computer program.

This application claims priority on Japanese Patent Application No. 2021-185181 filed on Nov. 12, 2021, the entire content of which is incorporated herein by reference.

### BACKGROUND ART

PATENT LITERATURE 1 discloses a traffic signal control device that controls traffic signal units included in one subarea with a common cycle length.

This traffic signal control device includes a determination means for determining whether or not to combine at least two adjacent subareas, based on an evaluation value considering influences of pulsation in the case where the at least two adjacent subareas are combined and the case where the subareas are not combined.

### CITATION LIST

### Patent Literature

PATENT LITERATURE 1: Japanese Laid-Open Patent Publication No. 2000-259985

### SUMMARY OF THE INVENTION

A device according to an aspect of the present disclosure includes: a storage unit configured to store therein probe information of a probe vehicle traveling on an inflow road to an intersection; and an information processing unit configured to execute a determination process of determining presence or absence of pulsation on the inflow road. The determination process includes a process of generating time series data of a delay index that is a traffic index indicating a degree of delay in vehicle traffic due to waiting at a traffic signal, the delay index being calculated from the probe information, and a process of determining presence or absence of pulsation, based on the time series data of the delay index.

A method according to an aspect of the present disclosure is an information processing method executed by an information processing device, and the method includes: storing therein probe information of a probe vehicle traveling on an inflow road to an intersection; and executing a determination process of determining presence or absence of pulsation on the inflow road. The determination process includes a process of generating time series data of a delay index that is a traffic index indicating a degree of delay in vehicle traffic due to waiting at a traffic signal, the delay index being calculated from the probe information, and a process of determining presence or absence of pulsation, based on the time series data of the delay index.

A computer program according to an aspect of the present disclosure is a computer program for causing a computer to function as: a storage unit configured to store therein probe information of a probe vehicle traveling on an inflow road to an intersection; and an information processing unit configured to execute a determination process of determining presence or absence of pulsation on the inflow road. The determination process includes a process of generating time series data of a delay index that is a traffic index indicating a degree of delay in vehicle traffic due to waiting at a traffic signal, the delay index being calculated from the probe information, and a process of determining presence or absence of pulsation, based on the time series data of the delay index.

The present disclosure can be realized not only as a system and a device having the characteristic configurations as described above, but also as a program for causing a computer to execute such characteristic configurations. In addition, the present disclosure can be realized as a semiconductor integrated circuit that realizes a part or all of the system and the device.

### BRIEF DESCRIPTION OF DRAWINGS

FIG. 1 shows an overall configuration of a traffic signal control system.

FIG. 2 is a block diagram showing an information processing device, an in-vehicle device of a probe vehicle, and a central apparatus which are included in the traffic signal control system.

FIG. 3 illustrates an example of road links where pulsation may occur.

FIG. 4 is a time chart illustrating the reason why pulsation occurs in a first link.

FIG. 5 is a time chart illustrating the reason why pulsation occurs in a second link.

FIG. 6 is a graph showing an example of travel paths when a plurality of vehicles pass through a road link.

FIG. 7 illustrates an example of a stop event that affects the accuracy of a delay time based on an average travel time over a link.

FIG. 8 illustrates an example of definition of variables used for calculating an average travel time over a traffic-signal waiting section.

FIG. 9 is a flowchart showing an example of a calculation process of calculating a delay time per vehicle due to waiting at a traffic signal.

FIG. 10 is a flowchart showing an example of a calculation process of calculating the total number of sections in the traffic-signal waiting section.

FIG. 11 illustrates an example of actual calculation of the total number of sections.

FIG. 12 is a flowchart showing an example of a determination process of determining presence or absence of pulsation.

FIG. 13 is a graph showing an example of time series data of the delay time.

FIG. 14 is a flowchart showing another example of the determination process of determining presence or absence of pulsation.

FIG. 15 is a graph showing an example of time series data of a queue length.

### DETAILED DESCRIPTION

### Problems to be Solved by the Present Disclosure

In the conventional traffic signal control device, the evaluation value considering influence of pulsation is calculated by reproducing an actual traffic situation with a traffic simulator. Therefore, setting of a road network and adjustment of parameters, for the traffic simulator, are required, which makes operations troublesome.

In addition, in the traffic simulator, signal control parameters (cycle length, split, etc.) for each subarea, which are required for calculation of the evaluation value, are determined from a congestion length and a saturation level based on a detection signal of a vehicle detector. Therefore, the traffic signal control device cannot be applied to a road where no vehicle detector is installed.

In view of the conventional problems described above, an object of the present disclosure is to determine an occurrence state of pulsation, regardless of presence or absence of a vehicle detector.

### Effects of the Present Disclosure

According to the present disclosure, an occurrence state of pulsation can be determined regardless of presence or absence of a vehicle detector.

### Outline of Embodiment of the Present Disclosure

An outline of an embodiment of the present disclosure will be listed and described below.

(1) An information processing device of the present embodiment includes: a storage unit configured to store therein probe information of a probe vehicle traveling on an inflow road to an intersection; and an information processing unit configured to execute a determination process of determining presence or absence of pulsation on the inflow road. The determination process includes a process of generating time series data of a delay index that is a traffic index indicating a degree of delay in vehicle traffic due to waiting at a traffic signal, the delay index being calculated from the probe information, and a process of determining presence or absence of pulsation, based on the time series data of the delay index.

According to the information processing device of the present embodiment, the information processing unit determines presence or absence of pulsation on the inflow road at the intersection, based on the time series data of the delay index calculated from the probe information. Therefore, an occurrence state of pulsation can be determined regardless of presence or absence of a vehicle detector.

(2) In the information processing device of the present embodiment, a delay time per vehicle due to waiting at a traffic signal, which is calculated from an average travel time over a traffic-signal waiting section in the inflow road, can be adopted as the delay index.

The reason is that when there is periodicity in change in the delay time, it is estimated that pulsation has occurred.

In addition, since the delay time is calculated from the average travel time over the traffic-signal waiting section, an accurate delay time that is not likely to include a stop event other than waiting at a traffic signal can be calculated, in contrast to the case of calculating the delay time from the average travel time over the link. Therefore, determination of presence or absence of pulsation can be accurately performed.

(3) In the information processing device of the present embodiment, the average travel time over the traffic-signal waiting section may be calculated according to formula (1) as follows.

$$\begin{matrix}[ Math . 1 ] & \\ Ttt = {\sum }_{i = 1}^{I} \{ Li / ( Vi / 3.6 ) \} & ( 1 )\end{matrix}$$

where Ttt: the average travel time (seconds) over the traffic-signal waiting section,
Li: a length (m) of a section i,
Vi: an average speed (km/h) over the section i,
I: total number of sections in the traffic-signal waiting section, and
i: an identification number of each section assigned in order from a downstream side.

In this case, the average travel time over the traffic-signal waiting section can be accurately calculated according to formula (1).

(4) In the information processing device of the present embodiment, the delay index may be calculated according to formula (2) as follows.

$$\begin{matrix}[ Math . 2 ] & \\ dav = Ttt - {\sum }_{i = 1}^{I} \{ Li / ( Ve / 3.6 ) \} & ( 2 )\end{matrix}$$

where dav: a delay time (average value) (seconds) per vehicle due to waiting at a traffic signal, and
Ve: an estimated speed (e.g., speed limit) (km/h).

In this case, the delay time can be accurately calculated according to formula (2).

(5) In the information processing device of the present embodiment, the storage unit may store therein a time threshold, regarding waiting at a traffic signal, for identifying whether the inflow road is saturated or unsaturated, and the information processing unit may determine, as the pulsation, periodically appearing peaks of the delay time equal to or greater than the time threshold.

The reason is as follows. That is, when the delay time is less than the time threshold, the inflow road is in the unsaturated state in which a queue of vehicles is cleared away by the end of the green interval. Therefore, even if the delay time changes within the range less than the time threshold, this change cannot be regarded as pulsation that promotes delay and stop in vehicle traffic.

(6) In the information processing device of the present embodiment, for example, a queue length due to waiting at a traffic signal on the inflow road may be adopted as the delay index.

The reason is that when there is periodicity in change in the queue length, it is estimated that pulsation has occurred.

(7) In the information processing device of the present embodiment, the queue length may be calculated according to formula (3) as follows.

$$\begin{matrix}[ Math . 3 ] & \\ Qu = {\sum }_{i = 1}^{I} Li & ( 3 )\end{matrix}$$

where Qu: a queue length (m) due to waiting at a traffic signal,
Li: a length (m) of a section i,
I: total number of sections in the traffic-signal waiting section, and
i: an identification number of each section assigned in order from a downstream side.

In this case, the queue length can be accurately calculated according to formula (3).

(8) In the information processing device of the present embodiment, the storage unit may store therein a distance threshold, regarding waiting at a traffic signal, for identifying whether the inflow road is saturated or unsaturated, and the information processing unit may determine, as the pulsation, periodically appearing peaks of the queue length equal to or greater than the distance threshold.

The reason is as follows. That is, when the queue length is less than the distance threshold, the inflow road is in the unsaturated state in which a queue of vehicles is cleared away by the end of the green interval. Therefore, even if the queue length changes within the range less than the distance threshold, this change cannot be regarded as pulsation that promotes delay and stop in vehicle traffic.

(9) A calculation method of the present embodiment is an information processing method executed by the information processing device according to any one of the above (1) to (8). Therefore, the information processing method of the present embodiment provides the same function and effect as those of the information processing device according to any one of the above (1) to (8).

(10) A computer program of the present embodiment is a computer program for causing a computer to function as the information processing device according to any one of the above (1) to (8). Therefore, the computer program of the present embodiment provides the same function and effect as those of the information processing device according to any one of the above (1) to (8).

### Details of Embodiment of the Present Disclosure

Hereinafter, an embodiment of the present disclosure will be described in detail with reference to the drawings. At least some parts of the embodiment described below can be combined together as desired.

### DEFINITION OF TERMS

In advance of describing the present embodiment in detail, terms used in this specification will be defined.

“Vehicle”: Every vehicle traveling on a road. Therefore, in addition to an automobile, a light automobile, and a trolley bus, a motorcycle is also a vehicle. A vehicle driving system is not limited to an internal combustion engine, and an electric vehicle and a hybrid vehicle are also vehicles.

In this embodiment, when simply mentioning a “vehicle”, this vehicle includes both a probe vehicle including an in-vehicle device capable of transmitting probe information, and an ordinary vehicle that does not transmit probe information to the outside.

“Probe information”: Various kinds of information on a probe vehicle traveling on a road, sensed by the probe vehicle. The probe information is also referred to as probe data or floating car data.

The probe information may include vehicle data such as identification information, a vehicle position, a vehicle speed, and a vehicle heading of a probe vehicle, and generation times of these data. As the probe information, information such as a position and an acceleration acquired by a smartphone, a tablet, etc., in the vehicle may be used.

“Probe vehicle”: A vehicle that senses probe information and transmits the probe information to the outside. Vehicles traveling on a road include both probe vehicles and vehicles other than the probe vehicles.

However, even an ordinary vehicle without an in-vehicle device capable of transmitting probe information is regarded as a probe vehicle as long as the vehicle has a smartphone, a tablet PC, or the like capable of transmitting probe information such as positional information of the vehicle to the outside.

“Signal control parameters”: Temporal elements of traffic signal indication, such as a cycle length, a split, and an offset, are collectively referred to as signal control parameters. Signal control parameters are also referred to as signal control constants.

“Cycle length”: A time period of one cycle from the start time of green (or red) of a traffic signal unit to the next start time of green (or red). In Japan, it is prescribed by law and regulations that a green signal light is called “blue”.

“Split”: The ratio of a time length assigned to each phase, to the cycle length. The split is generally expressed as a percentage or ratio. Strictly, the split is a value obtained by dividing an effective green interval by the cycle length.

“Offset”: In coordinated control or area control, an offset is a deviation of a certain time point of signal indication, e.g., a starting time point of major-road green light, from a reference time point common to a group of traffic signal units, or a deviation in the same signal indication starting time point between adjacent intersections. The former is referred to as an absolute offset and the latter is referred to as a relative offset. Each offset is represented by time (seconds) or a percentage of a cycle.

“Green interval”: A time slot in which a vehicle is given right of way at an intersection. The end time point of the green interval may be set to a turn-off time point of a green light unit in the earliest case, and to a turn-off time point of a yellow light unit in the latest case. At an intersection having an arrow light unit, the end time point of the green interval may be an end time point of a right-turn arrow.

“Red interval”: A time slot in which a vehicle is not given right of way at an intersection. The start time point of the red interval may be set to a turn-off time point of a green light unit in the earliest case, and to a turn-off time point of a yellow light unit in the latest case. At an intersection having an arrow light unit, the start time point of the red interval may be an end time point of a right-turn arrow.

As described above, in the present embodiment, the time slots included in one cycle are roughly divided into the green interval with the right of way and the red interval without the right of way. Therefore, assuming that the green interval is G, the red interval is R, and the cycle length is C, a relationship of C=G+R is satisfied.

Therefore, in the following description, R may be replaced with (C-G). That is, the red interval R may be a value indirectly calculated from the cycle length C and the green interval G.

“Queue”: A queue of vehicles that stop before an intersection, waiting for a traffic signal to change from red to green, for example. The length (m) of the queue is referred to as a “queue length”.

“Link”: A road section that has an upstream or downstream direction, and connects nodes such as intersections. A link is also referred to as a road link. When viewed from a certain intersection, a link in an inflow direction toward this intersection is referred to as an inflow link. When viewed from a certain intersection, a link in an outflow direction from this intersection is referred to as an outflow link.

“Travel time”: A time period required for a vehicle to travel a certain section. The travel time may include an intermediate stop time and a delay time.

“Link travel time”: A travel time in a case where a road section as a travel time calculation unit is a “link”, that is, a travel time required for a vehicle to travel from a starting end to a terminal end of one link.

“Traffic volume”: The number of passing vehicles within a unit time. Unless otherwise noted, the traffic volume is expressed by the number of passing vehicles in one hour. However, for control and evaluation purposes, a traffic volume in a unit of a shorter period such as seconds, 5 minutes, 15 minutes, etc., may be used. In general, the traffic volume increases in accordance with a traffic demand, but decreases when the traffic demand exceeds the traffic capacity.

“Oversaturation/unsaturation/near-saturation”: When some queuing vehicles are not cleared away by the end of green light, a traffic demand exceeds a traffic capacity. This state is referred to as an “oversaturated state”.

Meanwhile, the state in which the traffic demand is equal to or less than the traffic capacity and a queue of vehicles waiting at a traffic signal is cleared away by the end of green light, is referred to as an “unsaturated state”. The state in which a demand rate is high (e.g., 0.85 or more), but not oversaturated, is referred to as a “nearly-saturated state”. The demand rate is less than 1.

“Delay index”: A traffic index indicating the degree of delay in vehicle traffic due to waiting at a traffic signal. The unit of the delay index may be either time or length.

Therefore, the delay index whose unit is time is a delay time in vehicle traffic due to waiting at a traffic signal, and the delay index whose unit is length is a queue length due to waiting at a traffic signal.

### [Overall Configuration of System]

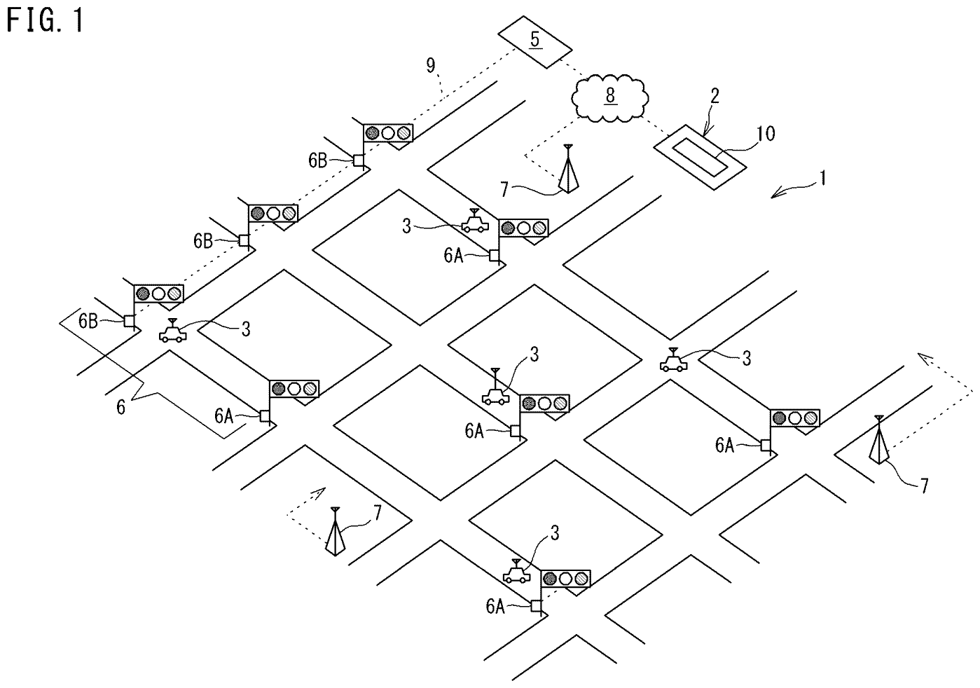

FIG. 1 shows an overall configuration of a traffic signal control system 1 according to the present embodiment.

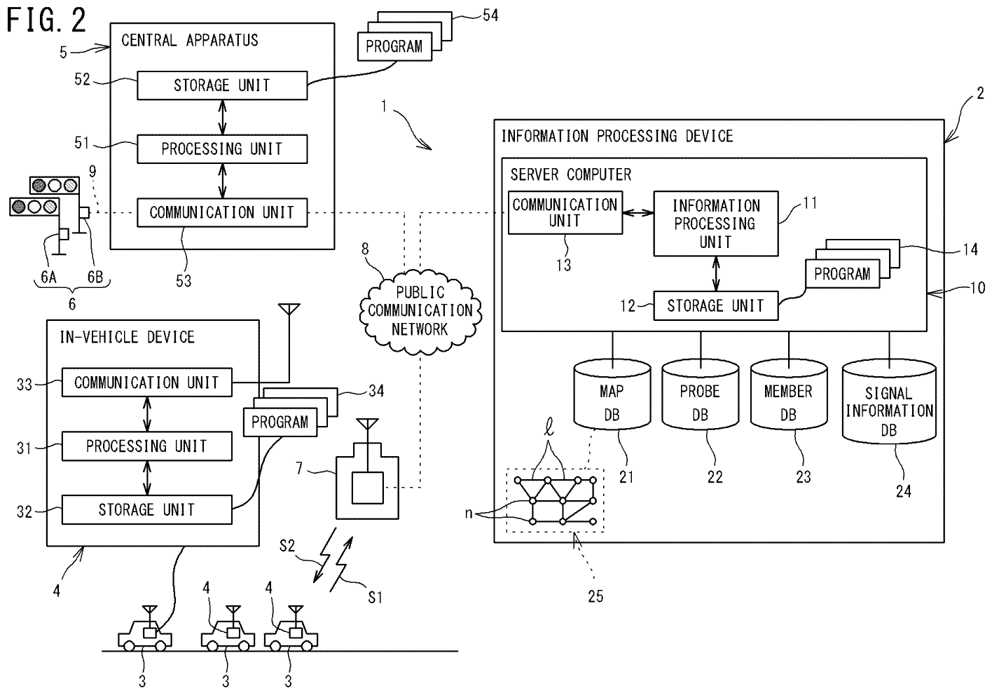

FIG. 2 is a block diagram showing an information processing device 2, an in-vehicle device 4 of a probe vehicle 3, and a central apparatus 5 which are included in the traffic signal control system 1.

As shown in FIG. 1 and FIG. 2, the traffic signal control system 1 includes: the information processing device 2 installed in a data center or the like; the in-vehicle devices 4 mounted in the probe vehicles 3; the central apparatus 5 installed in a traffic control center; traffic signal controllers 6 installed at intersections; and the like.

In the traffic signal control system 1 of the present embodiment, the information processing device 2 collects, from each probe vehicle 3, probe information including a vehicle position and its passing time, and acquires signal information of each intersection from the central apparatus 5 or the like. Using the probe information and the signal information, the information processing device 2 estimates, for example, an occurrence state of pulsation in an inflow road at an intersection.

An operation entity of the information processing device 2 is not particularly limited. For example, the operation entity of the information processing device 2 may be a manufacturer of vehicles 3, an IT company carrying out various types of information services, or another entity, or may be a public entity, in charge of traffic control, that operates the central apparatus 5.

The server operating system of the server of the information processing device 2 may be either an on-premises server or a cloud server.

The in-vehicle device 4 of the probe vehicle 3 is capable of wirelessly communicating with wireless base stations 7 (e.g., mobile base stations) in various places. Each wireless base station 7 is capable of communicating with the information processing device 2 via a public communication network 8 such as the Internet.

Therefore, the in-vehicle device 4 can wirelessly transmit uplink information S1 addressed to the information processing device 2, to the wireless base station 7. The information processing device 2 can transmit downlink information S2 addressed to a specific in-vehicle device 4, to the public communication network 8.

### [Configuration of Information Processing Device]

As shown in FIG. 2, the information processing device 2 includes a server computer 10, and a plurality of databases 21 to 24 constructed in the server computer 10. The server computer 10 includes an information processing unit 11, a storage unit 12, and a communication unit 13.

The databases 21 to 24 are electronic data constructed in a predetermined data arrangement in the storage unit 12. Of course, some or all of the databases 21 to 24 may be constructed in an external storage device (not shown) connected to the server computer 10.

The information processing unit (hereinafter also referred to as “processing unit”) 11 is an arithmetic processing device including a CPU (Central Processing Unit) and a RAM (Random Access Memory). The processing unit 11 may include an integrated circuit such as an FPGA (Field-Programmable Gate Array).

The processing unit 11 reads out computer programs 14 stored in the storage unit 12 into a main memory (RAM), and executes various types of information processing according to the programs 14.

The storage unit 12 is an auxiliary storage device including at least one non-volatile memory (recording medium) out of an HDD (Hard Disk Drive) and an SSD (Solid State Drive).

The storage unit 12 may include a flash ROM (Read Only Memory), a USB (Universal Serial Bus) memory, an SD card, or the like.

The computer programs 14 of the information processing device 2 include, for example, a program that causes the processing unit 11 to execute information processing such as calculation of a delay time due to a probe vehicle 3 waiting at a traffic signal, and determination of presence or absence of pulsation in a road link by using the delay time.

The communication unit 13 is a communication interface that communicates with the central apparatus 5 and the wireless base station 7 via the public communication network 8. The communication unit 13 is capable of receiving the uplink information S1 transmitted from the wireless base station 7, and transmitting the downlink information S2 to the wireless base station 7.

The uplink information S1 includes probe information transmitted from the in-vehicle device 4. The downlink information S2 includes, for example, a link travel time calculated by the processing unit 11.

The communication unit 13 is capable of receiving signal information, of an intersection included in a traffic control area, transmitted from the central apparatus 5 to the information processing device 2. The signal information of the intersection includes at least a cycle length and a red interval length at the intersection.

The communication unit 13 may be connected to the central apparatus 5 of the traffic control center via a dedicated communication line 9 instead of the public communication network 8.

The plurality of databases 21 to 24 include a map database 21, a probe database 22, a member database 23, and a signal information database 24.

In the map database 21, road map data 25 covering the entire country is recorded. The road map data 25 includes “intersection data” and “link data”.

The “intersection data” is data in which an intersection ID assigned to a domestic intersection is associated with position information of the intersection. The “link data” includes data in which the following information 1) to 4) is associated with a link ID of a specific link assigned to a domestic road.

Information 1) Position information of a start point, an end point, and an interpolation point of the specific link.

Information 2) Link ID connected to the start point of the specific link.

Information 3) Link ID connected to the end point of the specific link.

Information 4) Link cost of the specific link.

The road map data 25 constitutes a network corresponding to actual road alignment and traveling directions of roads. Therefore, the road map data 25 is a network in which road sections between nodes n representing intersections are connected by directed links 1 (lowercase letter “1”).

Specifically, the data structure of the road map data 25 includes a directed graph in which the nodes n, each being set for an intersection, are connected by a pair of directed links 1 in opposite directions. Therefore, for a one-way road, a node n is connected only to a directed link 1 in one direction.

The road map data 25 also includes: road type information indicating whether a specific directed link 1 corresponding to each road on the map is a general road or a toll road; facility information indicating the type of a facility such as a parking area or a tollgate included in a directed link 1; and the like.

In the probe database 22, probe information received from a probe vehicle 3 registered in the information processing device 2 in advance is accumulated for each identification information of the vehicle 3.

The probe information accumulated includes at least the vehicle position and the vehicle passing time. The probe information may include vehicle data such as a vehicle speed, a vehicle heading, and state information (stop/travel event) of the vehicle. A probe information sensing cycle has granularity that allows traveling history of the probe vehicle 3 to be accurately specified. The sensing cycle is 0.5 to 1.0 seconds, for example.

The member database 23 includes personal information such as the address and name of an owner (registered member) of each probe vehicle 3, vehicle identification number (VIN), and identification information of the in-vehicle device 4 (e.g., at least one of a MAC address, an email address, a telephone number, etc.).

In the signal information database 24, signal information including the cycle length and the red interval length of the inflow road at each intersection is accumulated for each intersection ID and each link ID.

The traffic signal controllers 6 installed at the intersections in the traffic control area include two types of traffic signal controllers, i.e., a first controller 6A and a second controller 6B as follows.

First controller 6A: A traffic signal controller that is not a target of remote control (coordinated control, wide-area control, etc.) by the central apparatus 5, and performs point control (fixed-time control, etc.) of independently determining a traffic light color.

Second controller 6B: A traffic signal controller that is a target of remote control (coordinated control, wide-area control, etc.) by the central apparatus 5.

The central apparatus 5 transmits signal information of the first controller 6A to the information processing device 2 only when the operation of the first controller 6A has been changed. The processing unit 11 updates the signal information of the first controller 6A included in the signal information database 24, to the received signal information.

The central apparatus 5 transmits signal information of the second controller 6B to the information processing device 2 for each predetermined control cycle (e.g., 1.0 to 2.5 minutes). The processing unit 11 updates the signal information of the second controller 6B included in the signal information database 24, to the received signal information.

### [Configuration of In-Vehicle Device]

As shown in FIG. 2, the in-vehicle device 4 is implemented by a computer device including a processing unit 31, a storage unit 32, a communication unit 33, and the like.

The processing unit 31 is an arithmetic processing device including a CPU and a RAM. The processing unit 31 reads out computer programs 34 stored in the storage unit 32, and performs various kinds of information processing according to the programs 34.

The storage unit 32 is an auxiliary storage device including at least one non-volatile memory (recording medium) out of an HDD and an SSD. The storage unit 32 may include a flash ROM, a USB memory, an SD card, or the like.

The computer programs 34 of the in-vehicle device 4 include, for example, programs that cause the CPU of the processing unit 31 to execute: sensing and generation of probe information; route searching for the probe vehicle 3; and image processing for displaying a search result on a display of a navigation device.

The communication unit 33 is a wireless communication device such as a gateway permanently installed in the vehicle 3, or a data communication terminal device (e.g., a smartphone, a tablet computer, or a notebook computer) temporarily installed in the vehicle 3. The communication unit 33 includes, for example, a GNSS (Global Navigation Satellite System) receiver. The processing unit 31 monitors the present position of the probe vehicle 3 in almost real time, based on GNSS position information received by the communication unit 33. Although it is preferable to use, for positioning, a global navigation satellite system such as a GNSS, other means may be employed.

The processing unit 31 measures vehicle data such as a vehicle position, a vehicle speed, a vehicle heading, and CAN (Controller Area Network) information of the probe vehicle 3 for each predetermined sensing cycle (e.g., 0.5 to 1.0 seconds), and stores the vehicle data together with the measurement time in the storage unit 32.

When the vehicle data has been accumulated for a predetermined recording time (e.g., 1 minute) in the storage unit 32, the communication unit 33 generates probe information including the accumulated vehicle data and the identification information of the probe vehicle 3, and performs uplink transmission of the generated probe information to the information processing device 2.

The in-vehicle device 4 includes an input interface (not shown) that receives operation input performed by a driver. The input interface is implemented by, for example, an input device attached to a navigation device, or an input device of a data communication terminal device mounted in the probe vehicle 3.

### [Configuration of Central Apparatus]

As shown in FIG. 2, the central apparatus 5 is implemented by a server computer that collectively controls the traffic signal controllers 6 installed at a plurality of intersections included in the traffic control area. The central apparatus 5 includes a processing unit 51, a storage unit 52, a communication unit 53, and the like.

The traffic signal controllers 6 in the traffic control area include: a point control type first controller 6A operating independently (in a stand-alone manner); and a second controller 6B as a target of remote control by the central apparatus 5.

The processing unit 51 is an arithmetic processing device including a CPU and a RAM. The processing unit 51 reads out computer programs 54 stored in the storage unit 52, and performs various kinds of information processing according to the programs 54.

The storage unit 52 is an auxiliary storage device including at least one non-volatile memory (recording medium) out of an HDD and an SSD. The storage unit 52 may include a flash ROM, a USB memory, an SD card, or the like.

The computer programs 54 of the central apparatus 5 include, for example, a program that causes the CPU of the processing unit 51 to execute remote control (traffic adaptive control) for the second controller 6B.

The processing unit 51 generates a signal control parameter by remote control, and then generates a signal control instruction to be executed by the second controller 6B being a target of remote control.

The signal control instruction is information regarding a light color switching timing of a traffic light unit corresponding to a newly generated signal control parameter, and is generated for each control cycle (e.g., 1.0 to 2.5 minutes) of remote control.

The communication unit 53 is a communication interface capable of executing both communication with the information processing device 2 via the public communication network 8, and communication with the second controller 6B via a dedicated communication line 9. The communication unit 53 may be connected to the information processing device 2 via a dedicated communication line 9.

The communication unit 53 transmits a signal control instruction, which is generated by the processing unit 51 for each control cycle of the signal control parameter, to the second controller 6B being a target of remote control.

The communication unit 53 transmits, to the information processing device 2, signal information including the cycle length and the red interval length being used by the first and second controllers 6A, 6B. The signal information of the second controller 6B is transmitted to the information processing device 2 for each control cycle (e.g., 1.0 to 2.5 minutes) of remote control.

### [Definition of Pulsation and Cause of Pulsation]

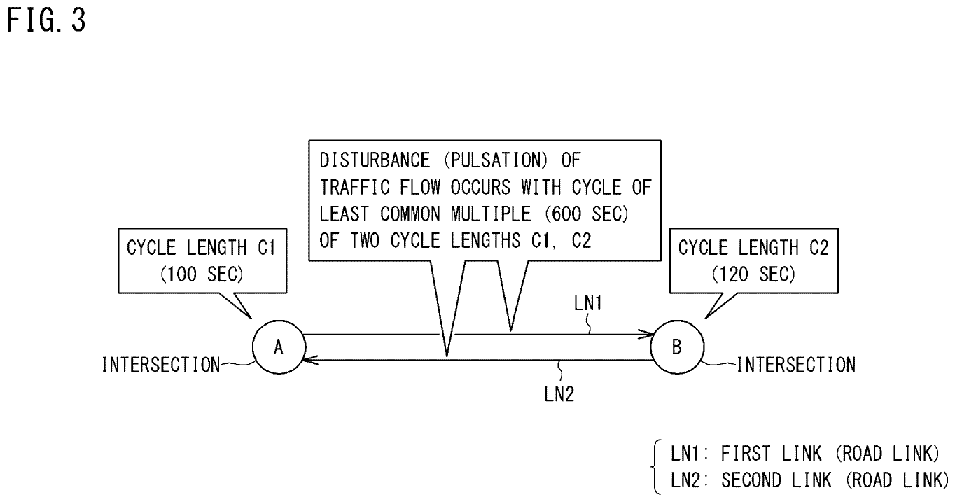

FIG. 3 illustrates an example of road links LN1, LN2 in which pulsation may occur.

Pulsation is periodic disturbance of a traffic flow which may occur when intersections located upstream and downstream of a road link have different cycle lengths. Such pulsation causes increased delays and stops in vehicle traffic.

Information on presence or absence of pulsation in a road link is useful for determining whether or not to combine subareas as described in PATENT LITERATURE 1, and also is important information in drafting a route guidance or a delivery schedule by a navigation system so as to avoid a road where pulsation has occurred.

As shown in FIG. 3, a road link LN1 from an intersection A to an intersection B (hereinafter referred to as “first link”) and a road link LN2 from the intersection B to the intersection A (hereinafter referred to as “second link”) are provided, and the cycle lengths at the intersections A, B are C1, C2 (>C1), respectively. Here, as an example, C1=100 seconds and C2=120 seconds.

In this case, in both the first and second links LN1, LN2, pulsation may occur with a cycle of the least common multiple (=600 seconds) of the cycle lengths C1, C2. The reason is as follows.

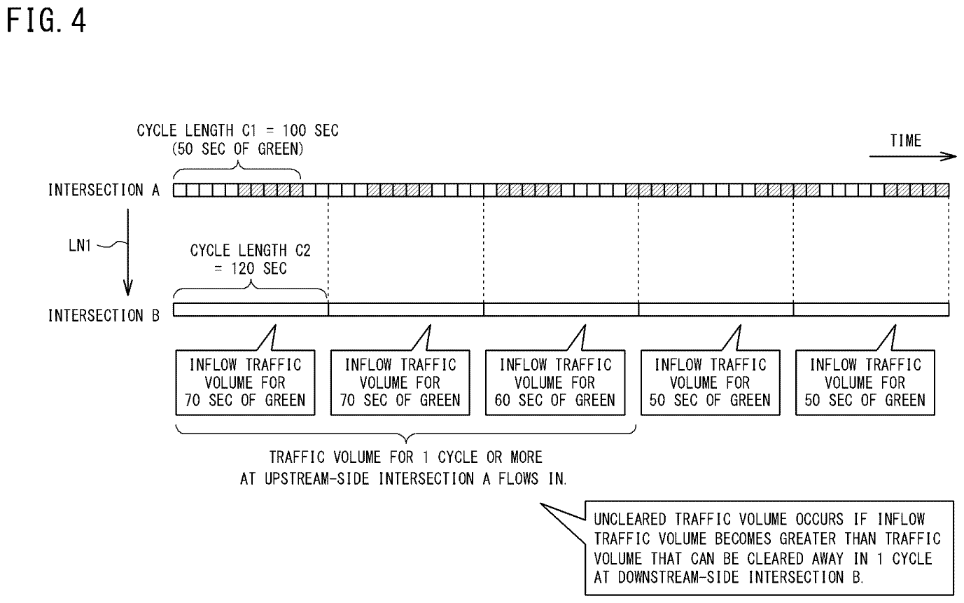

FIG. 4 is a time chart illustrating the reason why pulsation occurs in the first link LN1.

In FIG. 4, blank time slots (units of 10 seconds) indicate green intervals at the intersection A, and hatched time slots (units of 10 seconds) indicate red intervals at the intersection A.

As shown in FIG. 4, when the cycle length C1 of the upstream-side intersection A is smaller than the cycle length C2 of the downstream-side intersection B (C1<C2), a traffic volume for 1 cycle or more (traffic volume for 50 seconds of green or more) at the upstream-side intersection A flows in the downstream-side intersection B.

Specifically, the inflow traffic volume to the intersection B changes in the order of 70 seconds of green→70 seconds of green→60 seconds of green→50 seconds of green→50 seconds of green, for each cycle length C2 of the intersection B.

In this case, assuming that the inflow traffic volume that can be cleared away at the intersection B is a traffic volume for “60 seconds of green”, an uncleared traffic volume occurs in the first two cycles at the intersection B, and this uncleared traffic volume can be eliminated in the third and subsequent cycles. This is the reason of occurrence of pulsation in the first link LN1.

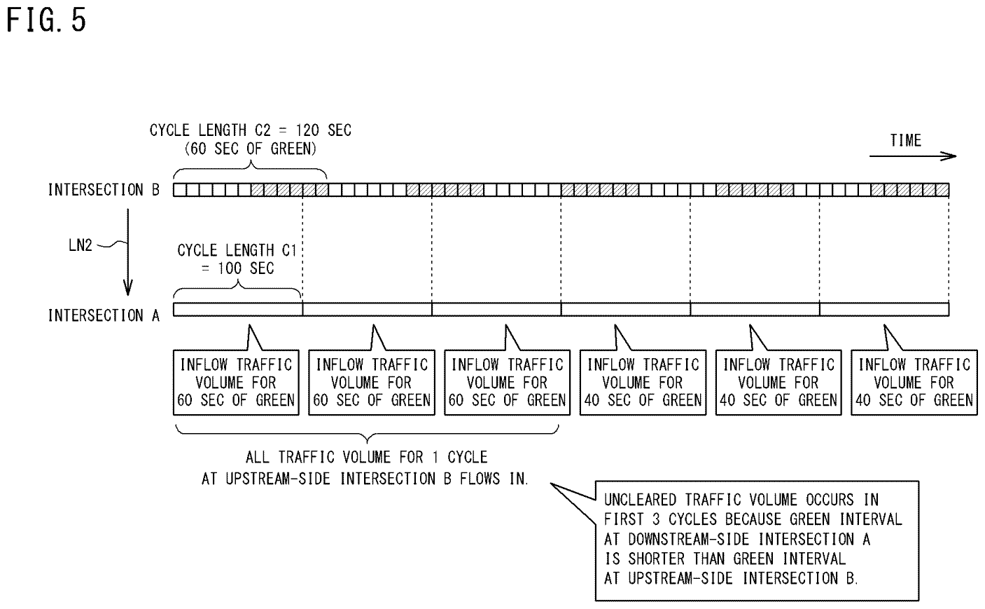

FIG. 5 is a time chart illustrating the reason why pulsation occurs in the second link LN2.

In FIG. 5, blank time slots (units of 10 seconds) indicate green intervals at the intersection B, and hatched time slots (units of 10 seconds) indicate red intervals at the intersection B.

As shown in FIG. 5, when the cycle length C2 of the upstream-side intersection B is larger than the cycle length C1 of the downstream-side intersection A (C2>C1), a traffic volume for 1 cycle or less (traffic volume for 60 seconds or less of green) at the upstream-side intersection B flows in the downstream-side intersection A.

Specifically, the inflow traffic volume to the intersection A changes in the order of 60 seconds of green→60 seconds of green→60 seconds of green→40 seconds of green→40 seconds of green→40 seconds of green, for each cycle length C1 of the intersection A.

In this case, since C2>C1, it is conceivable that the green interval at the intersection A is less than the green interval at the intersection B. Therefore, an uncleared traffic volume occurs in the first three cycles at the downstream-side intersection A, and this uncleared traffic volume is eliminated in the fourth and subsequent cycles. This is the reason of occurrence of pulsation in the second link LN2.

### [Procedure of Detecting Presence or Absence of Pulsation Using Probe Information]

As described above, the method described in PATENT LITERATURE 1, in which signal control parameters for each subarea required for calculation of an evaluation value considering influence of pulsation are determined from a congestion length and a saturation level based on a detection signal of a vehicle detector, cannot be applied to a road where no vehicle detector is installed.

In addition, since such a vehicle detector is installed at a relatively large distance (e.g., 200 m) from an intersection, it is difficult for the vehicle detector to accurately grasp a traffic index (hereinafter referred to as “delay index”) indicating the degree of delay in vehicle traffic due to waiting at a traffic signal, and therefore, the vehicle detector cannot precisely detect occurrence of pulsation.

In the present embodiment, a delay time dav per vehicle due to waiting at a traffic signal, which is a kind of the above delay index, is calculated using probe information that can be collected without a vehicle detector, and presence or absence of pulsation is determined based on the delay time dav. Specifically, determination of presence or absence of pulsation in the present embodiment includes procedures 1 to 3 as follows.

Procedure 1: Calculating an average travel time Ttt over a traffic-signal waiting section, from probe information (formula (1)).

Procedure 2: Calculating a delay time dav per vehicle from the average travel time Ttt (formula (2)).

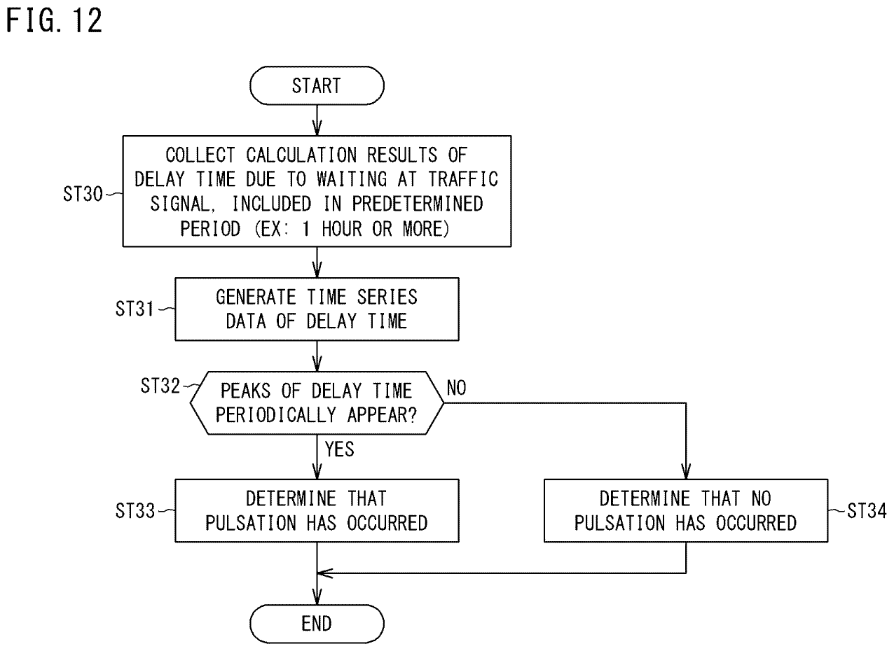

Procedure 3: Determining presence or absence of pulsation, based on periodicity of peaks of the delay time dav (FIG. 12).

According to the procedures 1 to 3, the present embodiment adopts, as a travel time calculated from probe information, not an average travel time Tt over a link between intersections, but an average travel time Ttt over a traffic-signal waiting section at an intersection located downstream of a determination target.

Therefore, a problem in the case of using an average travel time Tt over a link, and an advantage in the case of using an average travel time Ttt over a traffic-signal waiting section will be described below.

### [Relationship Between Link Travel Time and Delay Time Due to Waiting at Traffic Signal]

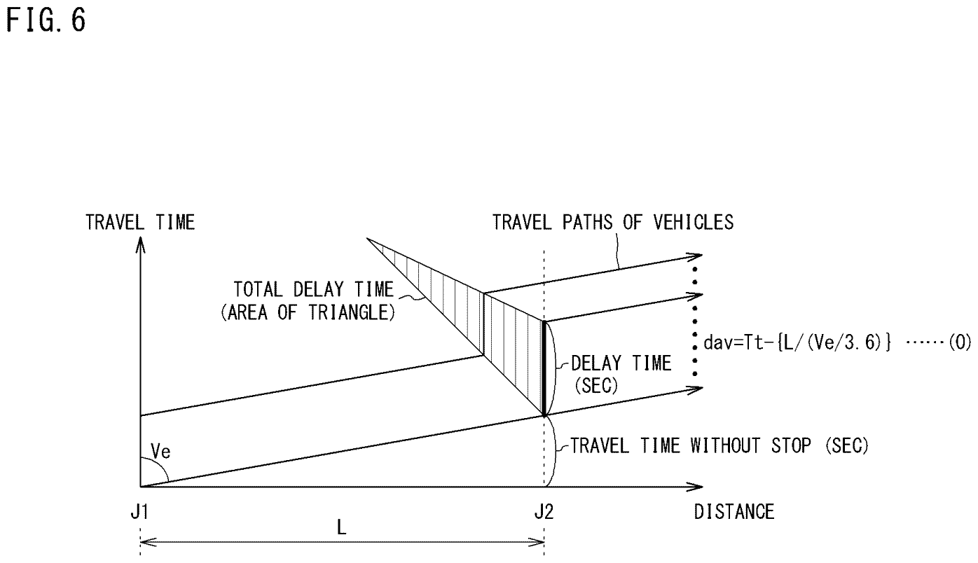

FIG. 6 is a graph showing an example of travel paths when a plurality of vehicles pass through a road link from an intersection J1 to an intersection J2.

The horizontal axis of the graph indicates distance from the intersection J1, and the vertical axis of the graph indicates travel time. Meanings of variables shown in FIG. 6 are as follows.
dav: Delay time (average value) (seconds) per vehicle due to waiting at a traffic signal
L: Link length (m) between intersections
Tt: Average travel time of probe vehicles (=link travel time between J1 and J2)
Ve: Estimated speed (e.g., speed limit) (km/h)
J1: Intersection located upstream of a target intersection
J2: Target intersection (stand-alone intersection) to be controlled by remote control

When a plurality of vehicles pass through the link between intersections J1 and J2, the delay time dav per vehicle due to waiting at a traffic signal is a value obtained by dividing the total delay time (area of a triangle) of all vehicles passing through the intersection J2 after waiting at the traffic signal, by the number of the vehicles.

It can be considered that the average travel time Tt of the plurality of probe vehicles 3 includes the above-described delay time dav per vehicle.

Therefore, the delay time dav per vehicle due to waiting at a traffic signal is a time obtained by subtracting a travel time (=L/(Ve/3.6)) in the case where the vehicle travels on the link at the estimated speed Ve without waiting at a traffic signal, from the average travel time Tt of the plurality of probe vehicles 3. That is, the delay time dav can be defined by the following formula (0).

$$dav = Tt - \{ L / ( Ve / 3.6 ) \} \qquad ( 0 )$$

However, the delay time dav based on the average travel time Tt over the link, calculated by formula (0), has a problem as follows.

### [Problem in Using Average Travel Time Over Link]

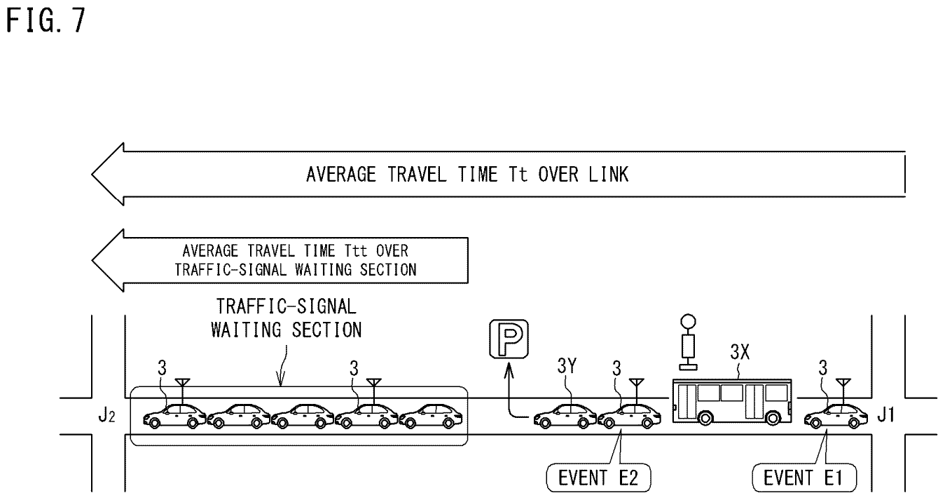

FIG. 7 illustrates an example of a stop event that affects the accuracy of the delay time dav based on the average travel time Tt over the link.

As shown in FIG. 7, as a stop event that can occur when a probe vehicle 3 passes through the link from the intersection J1 to the intersection J2, for example, the following events E1, E2 are considered in addition to waiting at the traffic signal in the intersection J2.

Event E1: Stop due to becoming the following vehicle of a bus 3X stopped at the bus stop

Event E2: Stop due to becoming the following vehicle of another vehicle 3Y that enters or exits a parking lot

However, in the above formula (0), the average travel time Tt over the link between the intersections J1 and J2 is adopted as the travel time obtained from the probe information.

Therefore, when the events E1, E2 have occurred on probe vehicles 3, the stop periods of the events E1, E2 are included in the average travel time Tt, and thus the delay time dav based on formula (0) becomes longer than the actual delay time. In this case, determination as to whether pulsation occurs, based on the delay time dav, becomes inaccurate.

### [Solving Method Using Average Travel Time Over Traffic-Signal Waiting Section]

In the present embodiment, in order to solve the above problem, an “average travel time Ttt over a traffic-signal waiting section” in the inflow road at the downstream intersection J2 is calculated (see the following formula (1)), instead of the “average travel time Tt over the link” which may include the stop periods of the events E1, E2 other than waiting at a traffic signal, and a delay time dav per vehicle due to waiting at a traffic signal on the inflow road at the intersection J2 is calculated using the average travel time Ttt (see the following formula (2)).

The average travel time Ttt over the traffic-signal waiting section does not include the stop periods of the events E1, E2 other than waiting at a traffic signal, or there is an extremely small possibility of including the stop periods.

Therefore, when the above calculation method is adopted, it is possible to accurately calculate the delay time dav per vehicle due to waiting at a traffic signal on the inflow road that flows in the intersection J2, regardless of presence or absence of stop events other than waiting at a traffic signal, such as the events E1, E2.

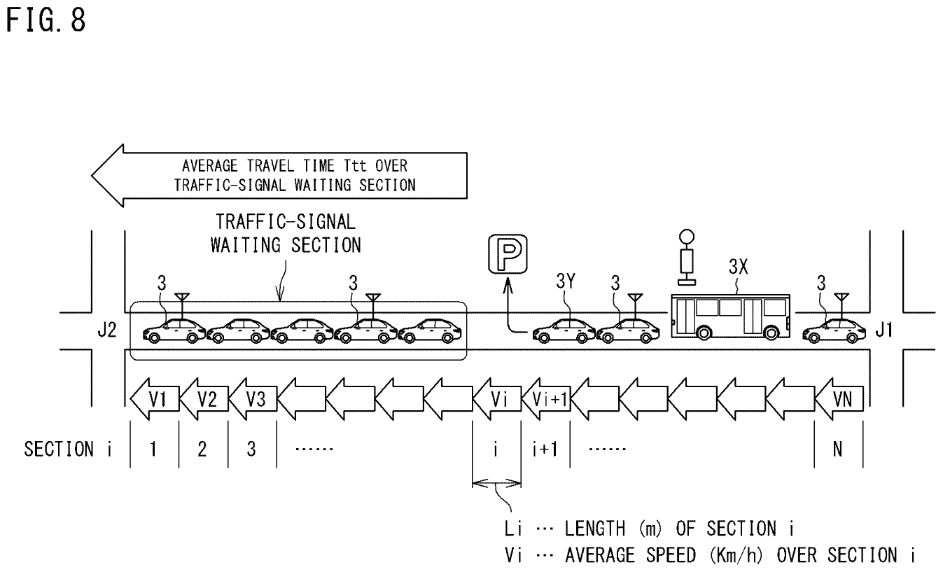

FIG. 8 illustrates an example of definition of variables used for calculating the average travel time Ttt over the traffic-signal waiting section. The variables include a section i (i=1, 2, . . . , N), a length Li (m) of a section i, and an average speed Vi (km/h) of probe vehicles 3 passing through the section i.

The section i is composed of a plurality of small sections obtained by dividing the link between the intersections J1 and J2 by a predetermined division number N. The length Li of the section i (hereinafter also referred to as “section length”) is a calculated value or a set value that is determined to be sufficiently shorter than a link length L between the intersections J1 and J2.

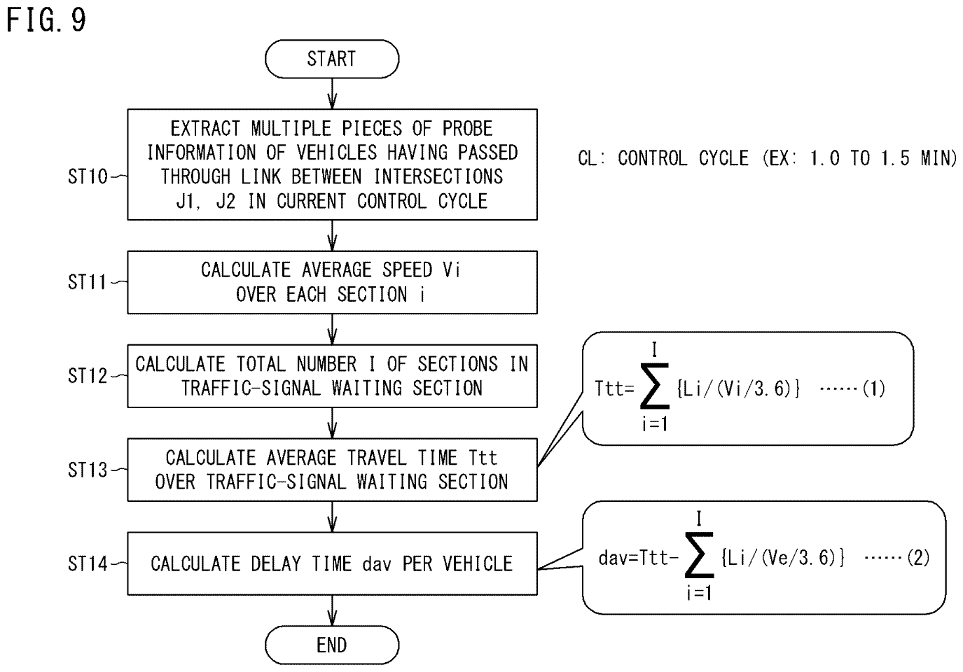

The processing unit 11 of the information processing device 2 executes the following processes a1, a2 as preprocessing of a calculation process of calculating the delay time dav (see FIG. 9).

Process a1: Setting a value (=L/N) obtained by dividing the link length L by the division number N, to a section length Li.

Process a2: Assigning an identification number (i=1, 2, . . . , N) of each section i in order from downstream to upstream of the link. Specifically, the identification number on the most downstream side is set to “1”, the identification number is incremented toward the upstream side, and the last identification number is set to “N”.

The processing unit 11 of the information processing device 2 may execute the following processes b1, b2 as preprocessing of the calculation process of calculating the delay time dav (see FIG. 9).

Process b1: Setting a value (=M+1) obtained by adding 1 to a quotient M which is obtained by dividing the link length L by a predetermined distance Lo, to a division number N of the link, and setting the remainder of the distance value, to a section length LN of the last section N.

Process b2: Assigning an identification number (i=1, 2, . . . , N) of each section i in order from downstream to upstream of the link. Specifically, the process b2 is the same as the process a2.

In the preprocessing described above, when the link between the intersections J1 and J2 has a branch node such as a intersection without a traffic signal, the section i is preferably divided at the branch node.

The section length Li of each section i (i=1, 2, . . . , N) included in the link may not necessarily be a constant distance, and the section length Li included in one link may be varied so as to be shortened in the downstream part of the link, and lengthened in the upstream part of the link.

In the preprocessing described above, the length (section length) Li of each of the plurality of sections i is preferably set to a value smaller than the installation interval (e.g., 200 m) of vehicle detectors that are actually installed on the road for measuring the vehicle speed. Thus, the measurement granularity of the vehicle average speed becomes finer than when the vehicle average speed is measured by the vehicle detector. Therefore, the traffic-signal waiting section, which depends on the total number I of sections, can be calculated more precisely, and the calculation accuracy of the delay time dav can be improved.

The average speed (hereinafter also referred to as “section speed”) Vi of the probe vehicles 3 over the section i is the average speed of the probe vehicles 3 calculated based on the positions and times of a plurality of pieces of probe information. A method for calculating the average speed Vi of each section i will be described later.

### [Delay Time Calculation Process]

FIG. 9 is a flowchart showing an example of a calculation process of calculating a delay time dav per vehicle due to waiting at a traffic signal, which is executed by the processing unit 11 of the information processing device 2. The calculation process shown in FIG. 9 is executed for each predetermined control cycle CL (e.g., 1.0 to 2.5 minutes).

As shown in FIG. 9, as a process of collecting data required for calculation of the delay time dav, the processing unit 11 firstly extracts probe information of a plurality of probe vehicles 3 that have passed through the link between the intersections J1 and J2 in the current control cycle CL (step ST10).

Specifically, the processing unit 11 extracts the probe information whose position is on the link and whose time is within the current control cycle CL, according to map matching performed to the probe information included in the probe database 22.

Next, the processing unit 11 calculates an average speed Vi over each section i (i=1, 2, . . . , N) included in the link, as a first process of calculating the delay time dav (step ST11).

Specifically, based on the position and time (speed may be used) of each probe vehicle 3 having passed through the link, the processing unit 11 calculates a travel speed of the probe vehicle 3 in the section i. Next, the processing unit 11 divides the total value of the travel speeds of the plurality of probe vehicles 3 in the section i by the number of the probe vehicles 3, thereby calculating the average speed Vi over the section i.

Next, the processing unit 11 calculates the total number I of sections within the traffic-signal waiting section in the inflow road toward the intersection J2 to be controlled, as a second process of calculating the delay time dav (step ST12).

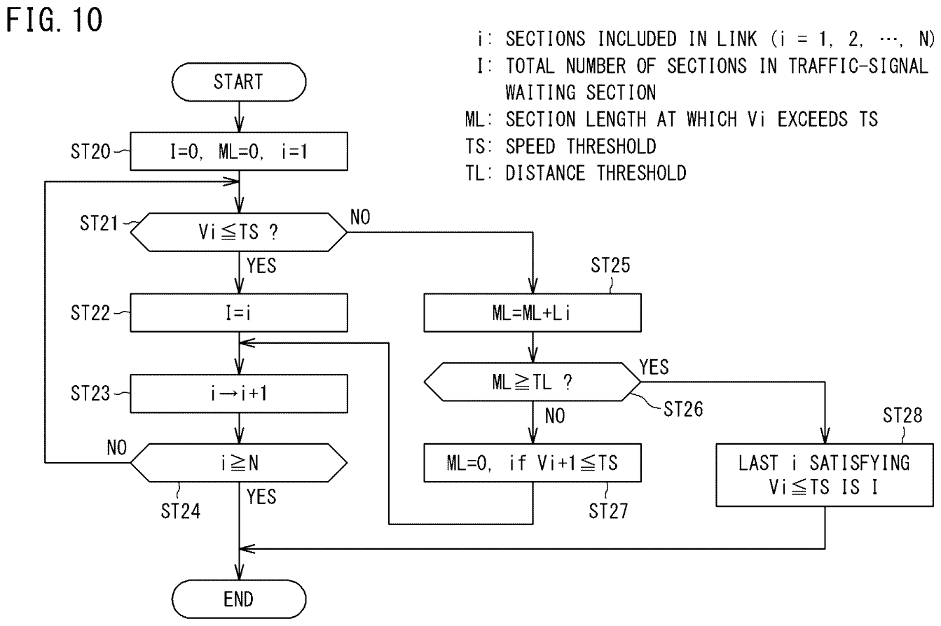

The total number I of sections corresponds to the identification number of the section i located at the most upstream side of the traffic-signal waiting section in the inflow road toward the intersection J2 to be controlled. The calculation process of calculating the total number I of sections (see FIG. 10) will be described later in detail.

Next, the processing unit 11 calculates the average travel time Ttt over the traffic-signal waiting section by using the total number I of sections, as a third process of calculating the delay time dav (step ST13). Specifically, the processing unit 11 calculates the average travel time Ttt according to the following formula (1).

As shown in formula (1), the average travel time Ttt over the traffic-signal waiting section is the total time of the average travel times (=Li/(Vi/3.6)) of the probe vehicles 3 over the respective sections i from the section 1 to the section total number I.

$$\begin{matrix}[ Math . 4 ] & \\ Ttt = {\sum }_{i = 1}^{I} \{ Li / ( Vi / 3.6 ) \} & ( 1 )\end{matrix}$$

Finally, the processing unit 11 calculates the delay time dav per vehicle due to waiting at a traffic signal in the traffic-signal waiting section by using the total number I of sections and the average travel time Ttt, as a fourth process of calculating the delay time dav (step ST14). Specifically, the processing unit 11 calculates the delay time dav according to the following formula (2).

As shown in formula (2), the delay time dav over the traffic-signal waiting section is a time obtained by subtracting, from the average travel time Ttt over the traffic-signal waiting section, the travel time (=> (Li/(Ve/3.6)) in the case where the probe vehicles 3 pass through the traffic-signal waiting section (from the section 1 to the section I) at the estimated speed Ve without waiting at a traffic signal.

$$\begin{matrix}[ Math . 5 ] & \\ dav = Ttt - {\sum }_{i = 1}^{I} \{ Li / ( Ve / 3.6 ) \} & ( 2 )\end{matrix}$$

In the calculation process of calculating the delay time dav shown in FIG. 9, the third process in step ST13 and the fourth process in step 14 may be executed using a single formula obtained by substituting formula (1) for Ttt on the right side of formula (2).

### [Calculation Process for Total Number of Sections in Traffic-Signal Waiting Section]

FIG. 10 is a flowchart showing an example of a calculation process of calculating the total number I of sections in the traffic-signal waiting section, which is executed by the processing unit 11 of the information processing device 2.

In FIG. 10, “ML” is a variable representing a section length at which a section speed Vi exceeds a speed threshold TS, “TS” represents the speed threshold, and “TL” represents a distance threshold.

The speed threshold TS is an estimated value of the average speed of vehicles when the vehicles stop before the intersection J2 due to waiting at a traffic signal. The speed threshold TS is a set value determined according to, for example, the size of the section length Li. Here, TS=25 km/h.

The distance threshold TL is an estimated value of the travel distance in the case where a vehicle traveling at an average speed exceeding the speed threshold TS continues traveling without intending to stop between the intersections J1 and J2. The distance threshold TL is a set value determined according to, for example, the magnitude of the speed threshold TS. Here, TL=100 m.

As shown in FIG. 10, the processing unit 11 of the information processing device 2 firstly initializes the variables (step ST20). Specifically, the processing unit 11 sets initial values of the total number I of sections, the section length ML, and the section i to I=0, ML=0, and i=1, respectively.

Next, the processing unit 11 determines whether or not Vi≤TS is satisfied (step ST21).

When the determination result in step ST21 is positive (when the section speed Vi in the section i being currently determined is equal to or less than the speed threshold TS), the processing unit 11 sets I=i (step ST22) and then increments the section i (step ST23).

Next, the processing unit 11 determines whether or not i>N is satisfied (step ST24).

When the determination result in step ST24 is positive, the processing unit 11 ends the process.

When the determination result in step ST24 is negative, the processing unit 11 returns the process to the stage before step ST21.

Through a loop including steps ST21 to ST24, a search process is executed as follows. That is, a section i, which satisfies a speed condition that the section speed Vi is equal to or less than the speed threshold TS, is searched for in order from the downstream side of the inflow road, and a section satisfying the speed condition is counted as a section i included in the traffic-signal waiting section.

When the determination result in step ST21 is negative (when the section speed Vi of the section i under determination exceeds the speed threshold TS), the processing unit 11 adds the section length Li of the section i under determination to the variable ML (step ST25), and then determines whether or not ML≥TL is satisfied (step ST26).

When the determination result in step ST26 is negative (when the variable ML is smaller than the distance threshold TL), the processing unit 11 resets the variable ML to 0 on the condition that Vi+1≤TS is satisfied (step ST27), and returns the process to the stage before step ST23. Note that “i+1” of the section speed Vi+1 is a suffix for the speed V.

Therefore, when Vi+1>TS is satisfied, the value of the variable ML is not reset but maintained, and the process is returned to the stage before step ST23.

The reason why the variable ML is reset to 0 when Vi+1≤TS is satisfied is because it is clear that the variable ML does not increase in the next section i+1 when the section speed Vi+1 of the next section i+1 is equal to or less than the speed threshold TS.

When the determination result in step ST26 is positive (when the variable ML is equal to or greater than the distance threshold TL), the processing unit 11 determines the identification number of the last section i satisfying Vi≤TS, as the total number I of sections in the traffic-signal waiting section (step ST28), and ends the process.

### [Example of Calculating Total Number of Sections in Traffic-Signal Waiting Section]

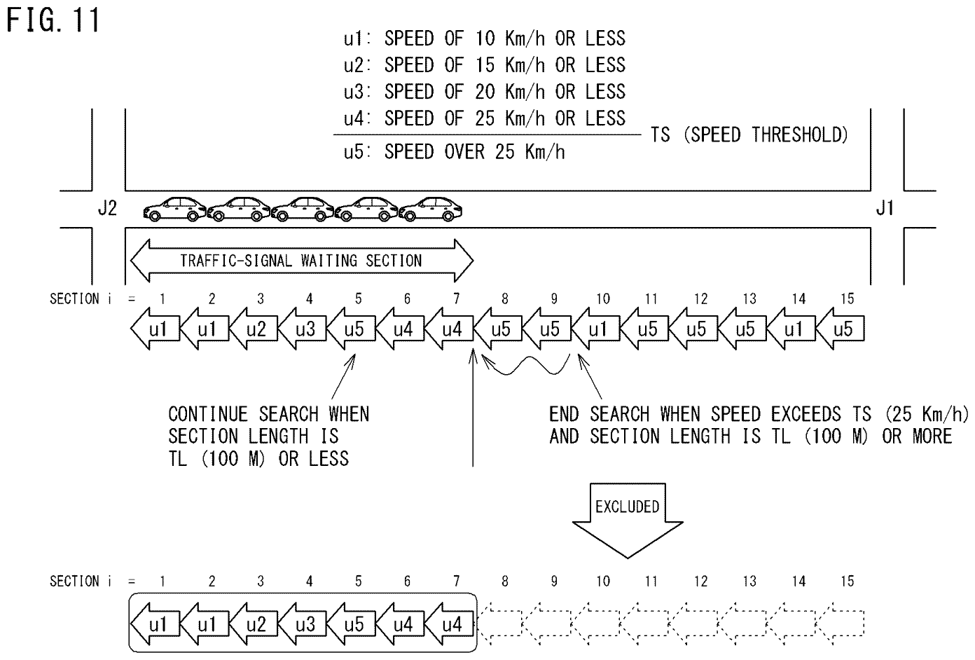

FIG. 11 illustrates an example of actual calculation of the total number I of sections.

In FIG. 11, numerical values from “u1” to “u5” are actually measured values of section speeds Vi obtained from probe information of a plurality of probe vehicles 3, and are the following numerical values, respectively. In addition, the division number N is 15, the section length Li of each section i is 50 m, TS is 25 km/h, and TL is 100 m.
u1=a speed of 10 km/h or less
u2=a speed of 15 km/h or less
u3=a speed of 20 km/h or less
u4=a speed of 25 km/h or less
u5=a speed over 25 km

As shown in FIG. 11, section speeds V1, V2 (=u1) are equal to or less than the speed threshold TS, and section speeds V3, V4 (=u3) are also equal to or less than the speed threshold TS. Therefore, the total number I of sections is counted up to “4” through the loop of steps ST21 to ST24 in FIG. 10.

Since a section speed V5 (=u5) exceeds the speed threshold TS (No in step ST21 in FIG. 10), the process exits the loop of steps ST21 to ST24 in FIG. 10, and the variable ML is equal to L5 (step ST25 in FIG. 10).

Since the value of the variable ML (L5=50 m) is less than the distance threshold TL (=100 m) and the section speed V6 (=u4) of the next section 6 is less than the speed threshold TS (No in step ST26 in FIG. 10), ML is reset to 0 and the search for the total number I of sections is continued (step ST27 in FIG. 10). Therefore, the total number I of sections is counted up to “5”.

The section speeds V6, V7 (=u4) are equal to or less than the speed threshold TS. Therefore, the total number I of sections is counted up to “7” through the loop of steps ST21 to ST24 in FIG. 10.

Since a section speed V8 (=u5) exceeds the speed threshold TS (No in step ST21 in FIG. 10), the process exits the loop of steps ST21 to ST24 in FIG. 10, and the variable ML is equal to L8 (step ST25 in FIG. 10).

Since the value of the variable ML (L8=50 m) is less than the distance threshold TL (=100 m) and a section speed V9 (=u5) of the next section 9 is equal to or greater than the speed threshold TS (No in step ST26 in FIG. 10), the search for the total number I of sections is continued while maintaining ML=L8 (step ST27 in FIG. 10). Therefore, the total number I of sections is counted up to “8”.

Since the section speed V9 (=u5) exceeds the speed threshold TS (No in step ST21 in FIG. 10), the process exits the loop of steps ST21 to ST24 in FIG. 10, and the variable ML is equal to L8+L9 (step ST25 in FIG. 10).

Since the value of the variable ML (L8+L9=100 m) is equal to or greater than the distance threshold TL (=100 m) (Yes in step ST26 in FIG. 10), the last section i (=7) that satisfies Vi≤TS is determined as the value of the total number I of sections (step ST28 in FIG. 10), and the process is ended.

In this case, the most upstream end of the last section i (=7) is regarded as the end of the traffic-signal waiting section. Therefore, the speeds Vi and section lengths Li of the sections 8 to 15 on the upstream side of the section 7 are excluded from the data for calculating the average travel time Ttt.

### [Determination Process of Determining Presence or Absence of Pulsation]

FIG. 12 is a flowchart showing an example of a determination process of determining presence or absence of pulsation, which is executed with the delay time dav being a monitoring target.

As shown in FIG. 12, the processing unit 11 of the information processing device 2 firstly collects calculation results of delay times dav due to waiting at a traffic signal, which are included in a predetermined time period (step ST30).

The predetermined time period is set to, for example, a time period sufficiently longer than a pulsation occurrence cycle (the least common multiple of the cycle lengths C1, C2 of the intersections A, B in FIG. 3).

Next, the processing unit 11 arranges the calculation results of the delay times dav in the order of the control cycles CL to generate time series data of the delay time dav (step ST31). A specific example of the time series data of the delay time dav will be described later in detail.

Next, the processing unit 11 determines whether or not periodic peaks of the delay time dav appear in the generated time series data of the delay time dav (step ST32). This determination method will also be described later.

When the determination result in step ST32 is positive, the processing unit 11 determines that pulsation has occurred in the road link being the determination target (step ST33).

When the determination result in step ST32 is negative, the processing unit 11 determines that no pulsation has occurred in the road link being the determination target (step ST34).

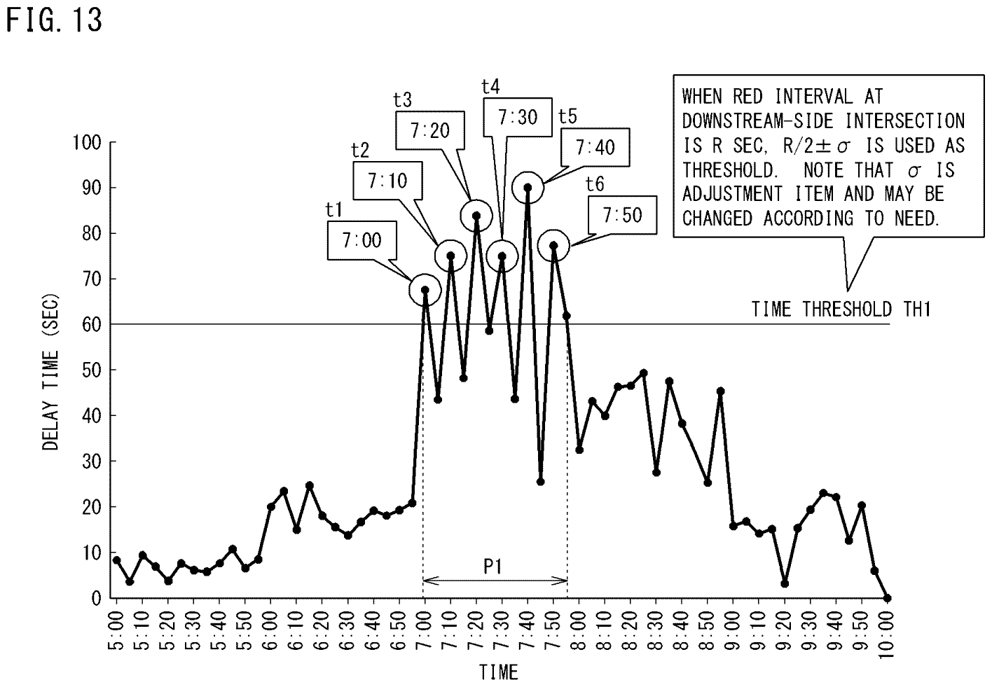

FIG. 13 is a graph showing an example of the time series data of the delay time dav. FIG. 13 shows the time series data in the case where the predetermined time period is 5 hours from AM 5:00 to AM 10:00. A time threshold TH1 shown in FIG. 13 is set in the storage unit 12 in advance.

The processing unit 11 of the information processing device 2 executes determination as to whether or not peaks of the delay time dav have periodically occurred, based on the time series data of the delay time dav shown in FIG. 13, for example (step ST32 in FIG. 12).

Specifically, the processing unit 11 firstly specifies a time period P1 in which the delay time dav is equal to or greater than the predetermined time threshold TH1, and extracts times (hereinafter referred to as “corresponding times”) corresponding to a plurality of peaks of the delay time dav included in the time period P1.

In FIG. 13, six peaks are included in the time period P1, and the corresponding times of the respective peaks are times t1 to t6 as follows. Therefore, in this case, the processing unit 11 extracts the six times t1 to t6 as the corresponding times.
Time t1: AM 7:00
Time t2: AM 7:10
Time t3: AM 7:20
Time t4: AM 7:30
Time t5: AM 7:40
Time t6: AM 7:50

Next, the processing unit 11 calculates a time difference between adjacent corresponding times (e.g., t1 and t2) among the extracted corresponding times t1 to t6 according to the following formulae, and calculates the rate of change in the time difference.

Time difference Δt21=t2−t1(=10 minutes)

Time difference Δt32=t3−t2(=10 minutes)

Time difference Δt43=t4−t3(=10 minutes)

Time difference Δt54=t5−t4(=10 minutes)

Time difference Δt65=t6−t5(=10 minutes)

Next, based on the rate of change in the calculated time differences Δt21 to Δt65, the processing unit 11 determines presence or absence of periodicity of peaks. Specifically, the processing unit 11 determines that the peaks are periodic when the rate of change in the time differences Δt21 to Δt65 is equal to or lower than a predetermined value (e.g., 10%), and determines that the peaks are not periodic when the rate of change exceeds the predetermined value.

In FIG. 13, since all the time differences Δt21 to Δt65 have the same value (=10 minutes) and the rate of change is zero, it is determined that the peaks of the delay time dav have periodically appeared.

The time threshold TH1 is set to, for example, a traffic signal waiting time value for identifying whether the inflow road being the determination target is in a saturated state or in an unsaturated state. That is, the time threshold TH1 is a time value of a delay time which allows estimation that the inflow road is saturated when dav≥TH1, and allows estimation that the inflow road is unsaturated when dav<TH1.

The reason is as follows. That is, when the delay time dav is less than the time threshold TH1, the inflow road is in the unsaturated state in which a queue of vehicles is cleared away by the end of the green interval. Therefore, even if the delay time dav changes within the range less than the time threshold TH1, this change cannot be regarded as pulsation that promotes delay and stop in vehicle traffic.

The time threshold TH1 may be set to (R/2)±σ when the red interval of the inflow road being the determination target is R. Note that σ is an adjustment value that is variable according to need.

### [Modification of Determination Process of Determining Presence or Absence of Pulsation]

In the above embodiment, a delay time dav per vehicle due to waiting at a traffic signal is adopted as the delay index for determining presence or absence of pulsation. However, for example, a “queue length Qu” on an inflow road at an intersection may be adopted as the delay index.

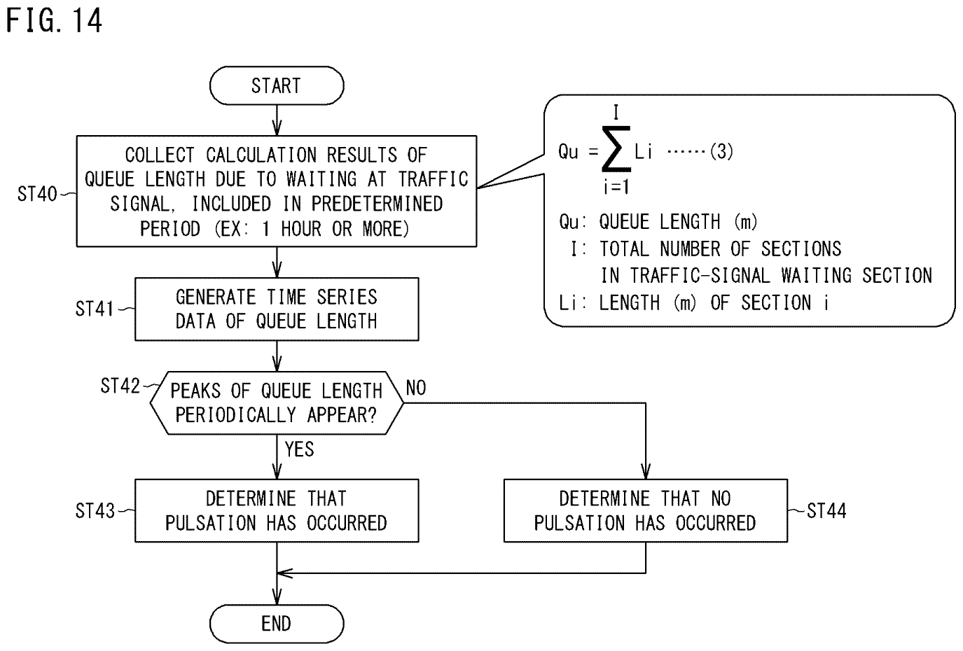

FIG. 14 is a flowchart showing another example of a determination process of determining presence or absence of pulsation, which is executed with a queue length Qu being a monitoring target.

As shown in FIG. 14, the processing unit 11 of the information processing device 2 initially collects calculation results of the queue length Qu due to waiting at a traffic signal, included in a predetermined time period (step ST40).

The predetermined time period is set to, for example, a time period (e.g., one hour or more) sufficiently longer than a pulsation occurrence cycle (the least common multiple of the cycle lengths C1, C2 of the intersections A, B in FIG. 3).

The queue length Qu is calculated based on the total number I of sections, in the traffic-signal waiting section, which is the calculation result in step ST12 in FIG. 9 (the calculation process in FIG. 10).

Specifically, the processing unit 11 calculates the queue length Qu due to waiting at a traffic signal, according to formula (3) which sums the lengths Li of sections i (i=1, 2, . . . ) up to the total number I of sections. This is because the total number I of sections is an identification number that can be regarded as the most upstream end (tail) of the traffic-signal waiting section. Note that “Li” in formula (3) is the same in meaning as the length of section i in FIG. 9.

$$\begin{matrix}[ Math . 6 ] & \\ Qu = {\sum }_{i = 1}^{I} Li & ( 3 )\end{matrix}$$

Next, the processing unit 11 arranges the calculation results of the queue length Qu in the order of the control cycles CL to generate time series data of the queue length Qu (step ST41). A specific example of the time series data of the queue length Qu will be described later.

Next, the processing unit 11 determines whether or not periodic peaks of the queue length Qu appear in the generated time series data of the queue length Qu (step ST42). This determination method will also be described later in detail.

When the determination result in step ST42 is positive, the processing unit 11 determines that pulsation has occurred in the road link being the determination target (step ST43).

When the determination result in step ST42 is negative, the processing unit 11 determines that no pulsation has occurred in the road link being the determination target (step ST44).

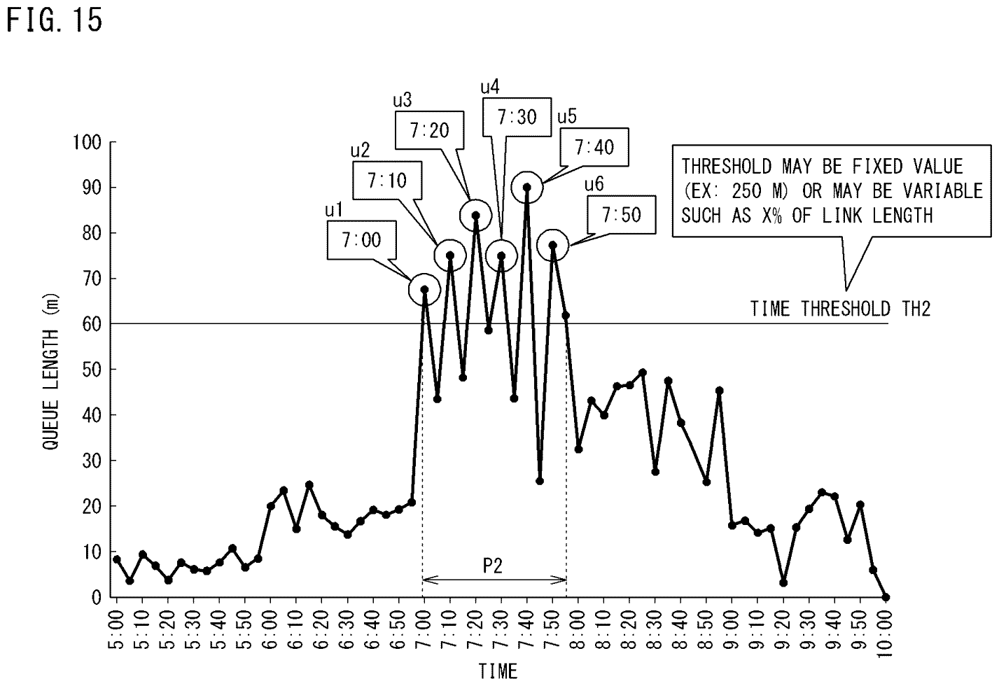

FIG. 15 is a graph showing an example of the time series data of the queue length Qu. FIG. 15 shows the time series data in the case where the predetermined time period is 5 hours from AM 5:00 to AM 10:00. A distance threshold TH2 shown in FIG. 15 is set in the storage unit 12 in advance.

The processing unit 11 of the information processing device 2 executes determination as to whether or not peaks of the queue length Qu have periodically occurred, based on the time series data of the queue length Qu shown in FIG. 15, for example (step ST42 in FIG. 14).

Specifically, the processing unit 11 firstly specifies a time period P2 in which the queue length Qu is equal to or greater than the predetermined threshold TH2, and extracts times (hereinafter referred to as “corresponding times”) corresponding to a plurality of peaks of the queue length Qu included in the time period P2.

In FIG. 15, six peaks are included in the time period P2, and the corresponding times of the respective peaks are times u1 to u6 as follows. Therefore, in this case, the processing unit 11 extracts the six times u1 to u6 as the corresponding times.
Time u1: AM 7:00
Time u2: AM 7:10
Time u3: AM 7:20
Time u4: AM 7:30
Time u5: AM 7:40
Time u6: AM 7:50

Next, the processing unit 11 calculates a time difference between adjacent corresponding times (e.g., u1 and u2) among the extracted corresponding times u1 to u6 according to the following formulae, and calculates the rate of change in the time difference.

Time difference Δu21=u2−u1(=10 minutes)

Time difference Δu32=u3−u2(=10 minutes)

Time difference Δu43=u4−u3(=10 minutes)

Time difference Δu54=u5−u4(=10 minutes)

Time difference Δu65=u6−u5(=10 minutes)

Next, based on the rate of change in the calculated time differences Δu21 to Δu65, the processing unit 11 determines presence or absence of periodicity of peaks. Specifically, the processing unit 11 determines that the peaks are periodic when the rate of change in the time differences Δu21 to Δu65 is equal to or lower than a predetermined value (e.g., 10%), and determines that the peaks are not periodic when the rate of change exceeds the predetermined value.

In FIG. 15, since all the time differences Δu21 to Δu65 have the same value (=10 minutes) and the rate of change is zero, it is determined that the peaks of the queue length Qu have periodically appeared.

The distance threshold TH2 is, for example, set to a traffic signal waiting distance value for identifying whether the inflow road between a determination target is in a saturated state or in an unsaturated state. That is, the distance threshold TH2 is a distance value of a queue length which allows estimation that the inflow road is saturated when Qu≥TH2, and allows estimation that the inflow road is unsaturated when Qu<TH2.

The reason is as follows. That is, when the queue length Qu is less than the distance threshold TH2, the inflow road is in the unsaturated state in which a queue of vehicles is cleared away by the end of the green interval. Therefore, even if the queue length Qu changes within the range less than the distance threshold TH2, this change cannot be regarded as pulsation that promotes delay and stop in vehicle traffic.

The distance threshold TH2 may be set to a queue length (hereinafter referred to as “maximum queue length”) corresponding to the maximum number of vehicles that can be cleared away by one green interval on the inflow road being the determination target.

The time threshold TH2 may be a fixed value (e.g., 250 m), or may be set to be variable such as X % of a link length.

### [Other Modifications]

The above-described embodiment (including modifications) is illustrative in all aspects and non-restrictive. The scope of the present disclosure includes all changes that come within the range of equivalency of the configurations recited in the claims.

For example, in the above-described embodiment, if the central apparatus 5 can execute collection and analysis of probe information, the central apparatus 5 may determine presence or absence of pulsation on an inflow road at an intersection by using the probe information that the central apparatus 5 has collected.

That is, the processing unit 51 of the central apparatus 5 may be caused to perform the determination process of determining presence or absence of pulsation by the processing unit 11 of the information processing device 2.

### REFERENCE SIGNS LIST

1 traffic signal control system
2 information processing device
3 probe vehicle (vehicle)
3X bus
3Y another vehicle
4 in-vehicle device
5 central apparatus (information processing device)
6 traffic signal controller
6A first controller
6B second controller
7 wireless base station
8 public communication network
9 communication line
10 server computer
11 information processing unit
12 storage unit
13 communication unit
14 computer program
21 map database
22 probe database
23 member database
24 signal information database
25 road map data
31 processing unit
32 storage unit
33 communication unit
34 computer program
51 processing unit
52 storage unit
53 communication unit
54 computer program

1. An information processing device, comprising:
a storage unit configured to store therein probe information of a probe vehicle traveling on an inflow road to an intersection; and
an information processing unit configured to execute a determination process of determining presence or absence of pulsation on the inflow road, wherein
the determination process includes
a process of generating time series data of a delay index that is a traffic index indicating a degree of delay in vehicle traffic due to waiting at a traffic signal, the delay index being calculated from the probe information, and
a process of determining presence or absence of pulsation, based on the time series data of the delay index.

2. The information processing device according to claim 1, wherein
the delay index is a delay time per vehicle due to waiting at a traffic signal, and the delay time is calculated from an average travel time over a traffic-signal waiting section in the inflow road.

3. The information processing device according to claim 2, wherein
the average travel time over the traffic-signal waiting section is calculated according to formula (1) as follows.
$$\begin{matrix}[ Math . 1 ] & \\ Ttt = {\sum }_{i = 1}^{I} \{ Li / ( Vi / 3.6 ) \} & ( 1 )\end{matrix}$$
where Ttt: the average travel time (seconds) over the traffic-signal waiting section,
Li: a length (m) of a section i,
Vi: an average speed (km/h) over the section i,
I: total number of sections in the traffic-signal waiting section, and
i: an identification number of each section assigned in order from a downstream side.

4. The information processing device according to claim 3, wherein
the delay index is calculated according to formula (2) as follows.
$$\begin{matrix}[ Math . 2 ] & \\ dav = Ttt - {\sum }_{i = 1}^{I} \{ Li / ( Ve / 3.6 ) \} & ( 2 )\end{matrix}$$
where dav: a delay time (average value) (seconds) per vehicle due to waiting at a traffic signal, and
Ve: an estimated speed (e.g., speed limit) (km/h).

5. The information processing device according to claim 2, wherein
the storage unit stores therein a time threshold, regarding waiting at a traffic signal, for identifying whether the inflow road is saturated or unsaturated, and
the information processing unit determines, as the pulsation, periodically appearing peaks of the delay time equal to or greater than the time threshold.

6. The information processing device according to claim 1, wherein
the delay index is a queue length due to waiting at a traffic signal on the inflow road.

7. The information processing device according to claim 6, wherein
the queue length is calculated according to formula (3) as follows.
$$\begin{matrix}[ Math . 3 ] & \\ Qu = {\sum }_{i = 1}^{I} Li & ( 3 )\end{matrix}$$
where Qu: a queue length (m) due to waiting at a traffic signal,
Li: a length (m) of a section i,
I: total number of sections in the traffic-signal waiting section, and
i: an identification number of each section assigned in order from a downstream side.

8. The information processing device according to claim 6, wherein
the storage unit stores therein a distance threshold, regarding waiting at a traffic signal, for identifying whether the inflow road is saturated or unsaturated, and
the information processing unit determines, as the pulsation, periodically appearing peaks of the queue length equal to or greater than the distance threshold.

9. An information processing method executed by an information processing device, comprising:
storing therein probe information of a probe vehicle traveling on an inflow road to an intersection; and
executing a determination process of determining presence or absence of pulsation on the inflow road, wherein
the determination process includes
a process of generating time series data of a delay index that is a traffic index indicating a degree of delay in vehicle traffic due to waiting at a traffic signal, the delay index being calculated from the probe information, and
a process of determining presence or absence of pulsation, based on the time series data of the delay index.

10. A non-transitory computer readable storage medium storing a computer program for causing a computer to function as:
a storage unit configured to store therein probe information of a probe vehicle traveling on an inflow road to an intersection; and
an information processing unit configured to execute a determination process of determining presence or absence of pulsation on the inflow road, wherein
the determination process includes
a process of generating time series data of a delay index that is a traffic index indicating a degree of delay in vehicle traffic due to waiting at a traffic signal, the delay index being calculated from the probe information, and
a process of determining presence or absence of pulsation, based on the time series data of the delay index.
